(19) United States
(12) Patent Application Publication
(10) Pub. No.: US 2023/0134349 A1
(43) Pub. Date: May 4, 2023

(54) HARDWARE PROTECTION MODULE

(71) Applicant: INTERNATIONAL BUSINESS MACHINES CORPORATION, ARMONK, NY (US)

(72) Inventors: Colin Edward MASTERSON, ROCHESTER, MN (US); Tory JOHNSON, ROCHESTER, MN (US); Gunnar MILLS, DENVER, CO (US); John R. DANGLER, ROCHESTER, MN (US); Austin CARTER, ROCHESTER, MN (US)

(21) Appl. No.: 17/452,802

(22) Filed: Oct. 29, 2021

(51) Int. Cl. G06F 21/72; G06F 21/86

(52) U.S. Cl. CPC G06F 21/72; G06F 21/86

(57) ABSTRACT

A system and a method for a hardware security module having enhanced security features is disclosed. The hardware security module includes a card configured to be plugged into a computer system and at least one cryptographic chip disposed on the card. A security cover is placed over and encloses the cryptographic chip. The security cover has a first half and a second half. The first half of the security cover is located on the first side of the card, and the second half of the security cover is located on a second side of the card. To enhance the security a flex cable that has at least one sensor or circuitry configured to detect tampering with the hardware security module is embedded within the material of the security cover.

### BACKGROUND

Aspects of the present disclosure relate to secure processing, and more specifically to a hardware security module having embedded security features.

Cryptography is an essential tool in secure processing. A hardware security module (HSM) is a physical computing device that safeguards and manages digital keys for strong authentication and provides crypto-processing. The HSM must remain secure even if adversaries carry out destructive analysis of one or more devices. Many servers operate in distributed environments where it is difficult or impossible to provide complete physical security for sensitive processing. In some applications, the motivated adversary is the end user. The HSM is a device that you can trust even though you cannot control its environment.

### SUMMARY

According to embodiments a hardware security module having enhanced security features is disclosed. The hardware security module includes a card configured to be plugged into a computer system and at least one cryptographic chip disposed on the card. A security cover is placed over and encloses the cryptographic chip. The security cover has a first half and a second half. The first half of the security cover is located on the first side of the card, and the second half of the security cover is located on a second side of the card. To enhance the security a flex cable that has at least one sensor or circuitry configured to detect tampering with the hardware security module is formed within the material of the security cover.

According to embodiments a method for making a security cover is disclosed. A mold for the security cover is created. Once the mold has been made a security flex cable is placed inside the mold. The mold is sealed and a liquefied material is poured into to the mold to cast the security cover. The material is cooled and the flex cable is embedded within the security cover.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a diagrammatic illustration of a hardware security module (HSM) according to embodiments of the present disclosure.

FIG. 2 is a diagrammatic illustration of the bottom of a hardware security module according to embodiments of the present disclosure.

FIG. 3 is a top view of the card which is protected by the hardware security module according to embodiments of the present disclosure.

FIG. 4 is a cutaway view of the hardware security module according to embodiments of the present disclosure.

FIG. 5 is a cutaway side view of the hardware security module according to embodiments according to embodiments of the present disclosure.

FIG. 6 is a cutaway bottom view of the hardware security module according to embodiments of the present disclosure.

FIG. 7 is a flow diagram illustrating a process for making the security cover 130 for the hardware security module according to embodiments of the present disclosure.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

Aspects of the present disclosure relate to secure processing, more particular aspects relate to a hardware security module having embedded security features. While the present disclosure is not necessarily limited to such applications, various aspects of the disclosure may be appreciated through a discussion of various examples using this context.

Cryptography is an essential tool in secure processing. A hardware security module (HSM) is a physical computing device that safeguards and manages digital keys for strong authentication and provides crypto-processing. The HSM must remain secure even if adversaries carry out destructive analysis of one or more devices. Many servers operate in distributed environments where it is difficult or impossible to provide complete physical security for sensitive processing. In some applications, the motivated adversary is the end user. The HSM is a device that you can trust even though you cannot control its environment.

The Federal Information Processing Standard (FIPS) 140-2 is a United States government security standard that specifies requirements for security modules. FIPS 140-2 has a 4 level system of which level 3 and level 4 require tamper resistant circuitry. This requires that the hardware security module has to be able to detect the smallest intrusion into the secure area of the card. Physical security mechanisms required at Level 3 are intended to have a high probability of detecting and responding to attempts at physical access, use or modification of the cryptographic module. The physical security mechanisms include the use of strong enclosures and tamper-detection/response circuitry that zeroes all plaintext content security policies when the removable covers/doors of the cryptographic module are opened. Level 4 provides the highest level of security. At this security level, the physical security mechanisms provide a complete envelope of protection around the cryptographic module with the intent of detecting and responding to all unauthorized attempts at physical access. Penetration of the cryptographic module enclosure from any direction has a very high probability of being detected, resulting in the immediate deletion of all plaintext content security policies.

A motivated adversary will attempt to access the components of a hardware security module using many different approaches. However, the goal of the adversary is to avoid detection by the onboard detection systems. For example, by strategically drilling the security cover the adversary may be able to avoid the security circuitry all together in accessing the underlying components. As such the present disclosure provides an approach that makes it much more difficult to avoid the security circuitry of the hardware security module.

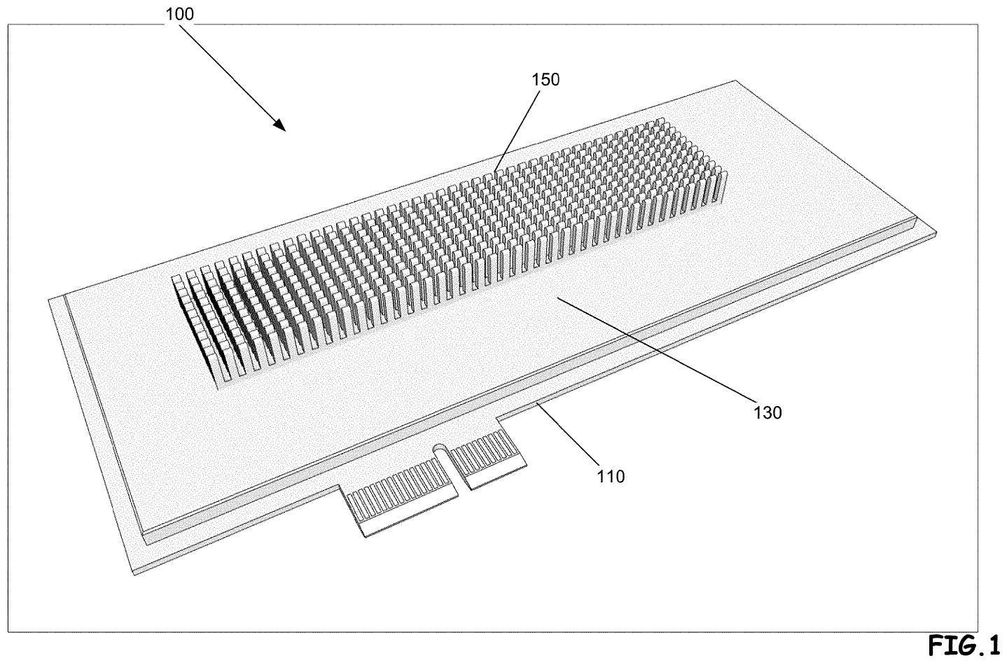

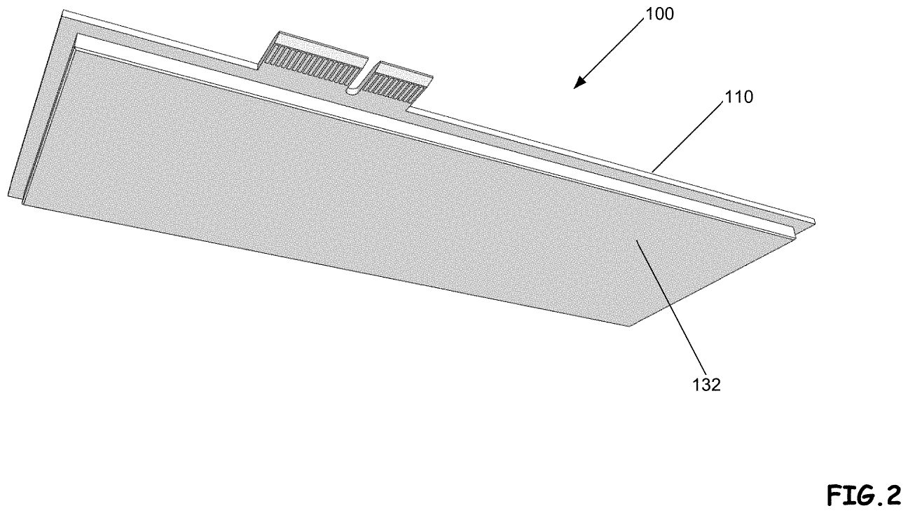

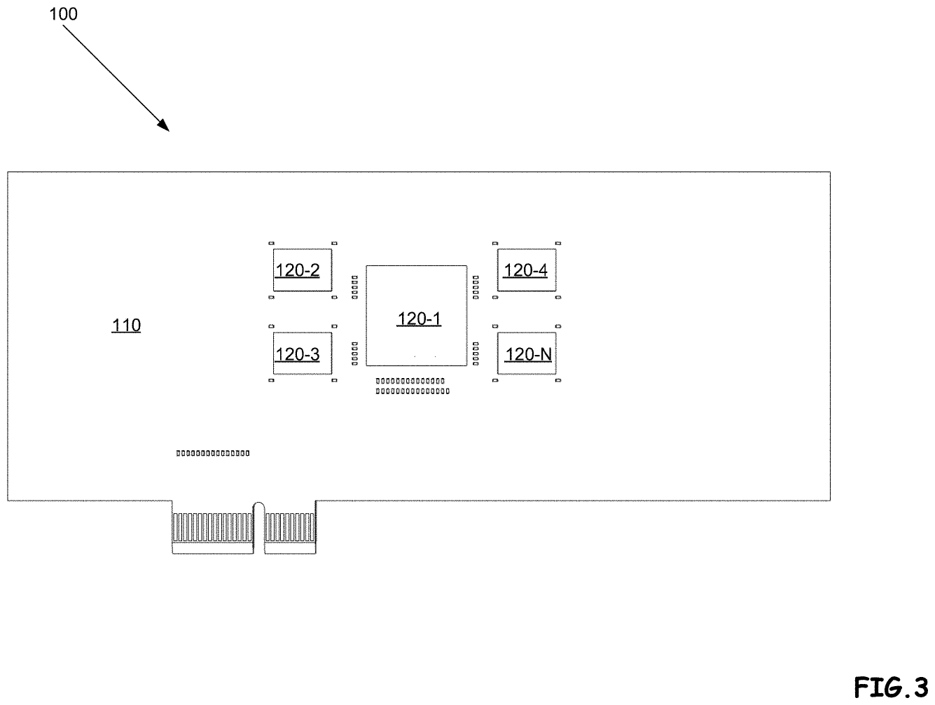

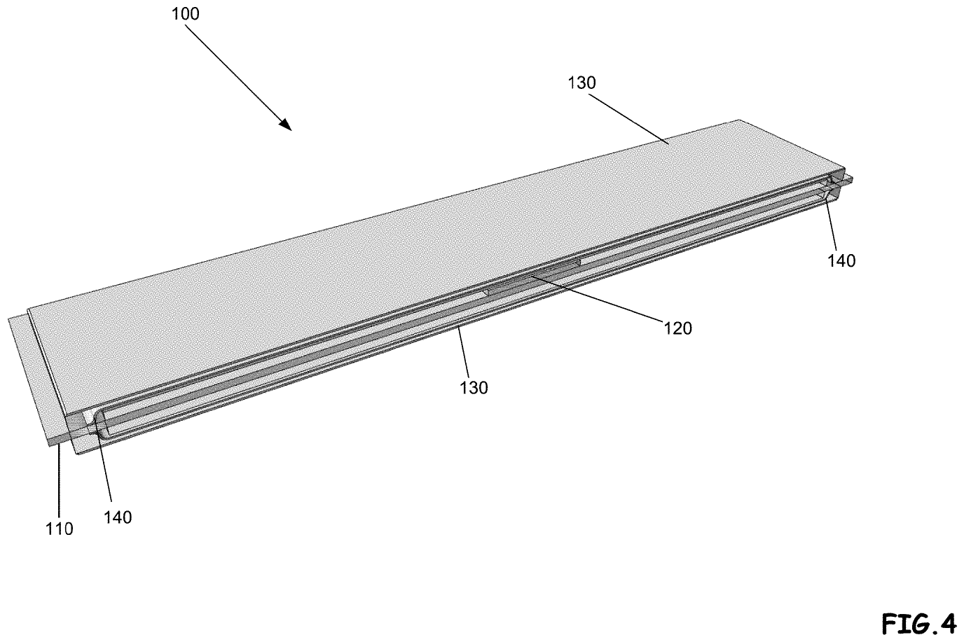

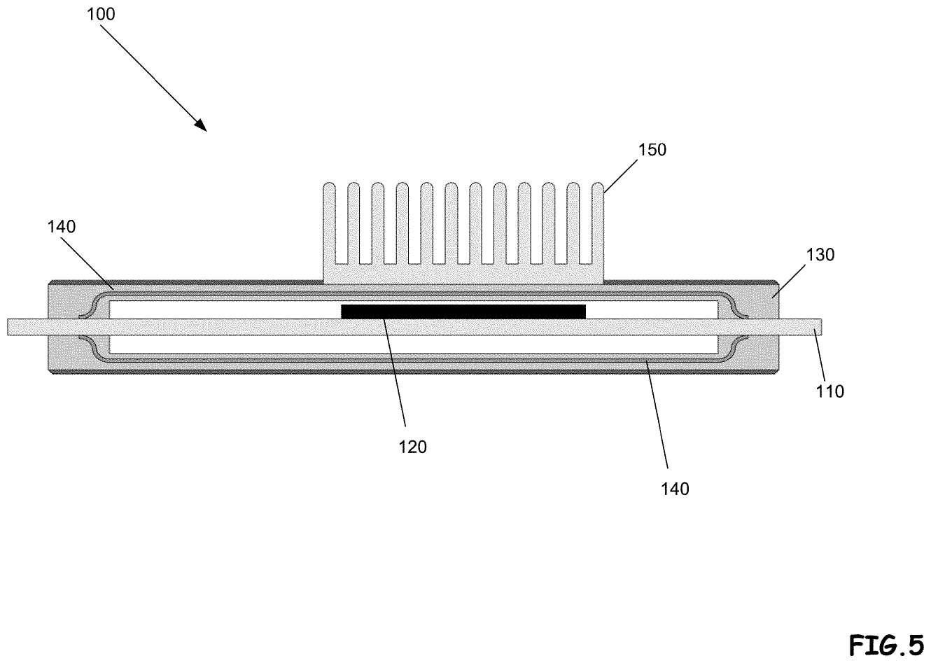

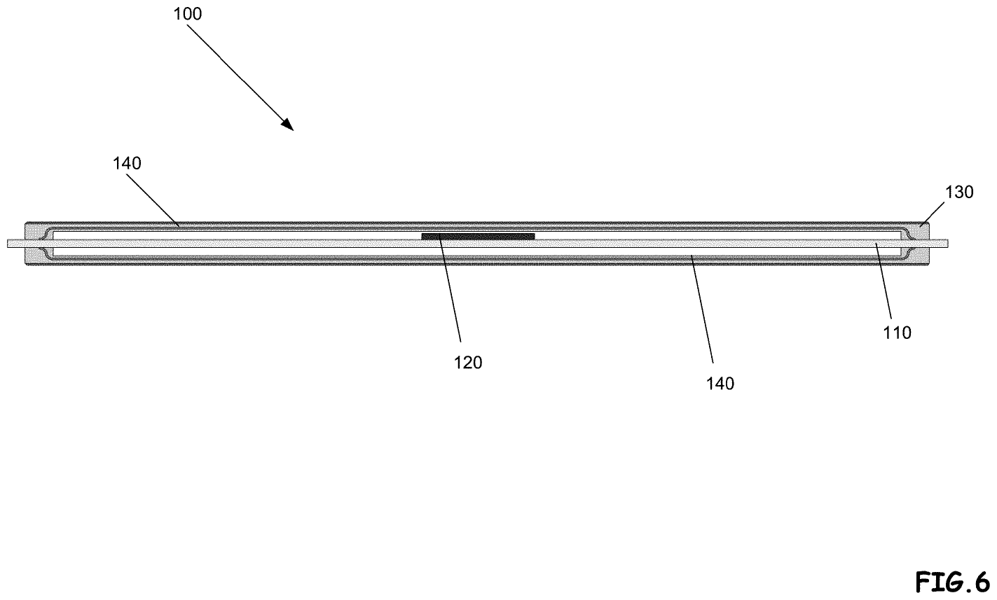

FIG. 1 is a diagrammatic illustration of a hardware security module (HSM) according to embodiments. FIG. 2 is a diagrammatic illustration of the bottom of a hardware security module according to embodiments. FIG. 3 is a top view of the card which is protected by the hardware security module. FIG. 4 is a cutaway view of the hardware security module according to embodiments. FIG. 5 is a cutaway side view of the hardware security module according to embodiments. FIG. 6 is a cutaway bottom view of the hardware security module according to embodiments. For purposes of this disclosure FIGS. 1-6 will be discussed together. The hardware security module 100 includes a card 110, at least one cryptographic chip 120, a security cover 130, and a flex cable 140. While the present disclosure discusses a hardware security module, the ideas presented herein can be applied to other applications where items need to be secured from tampering. Further, while the security cover is illustrated as rectangular in shape, other shapes can be used depending on the particular needs of the cover.

The card 110 is part of the hardware security module that is plugged into a computer system or server. The card 110 can be a printed circuit board that includes circuitry that allows for the management of digital keys, encrypting and decrypting of digital signatures, authentication and/or other cryptographic functions. 130 While the present disclosure discusses the hardware security module as being a card 110, it should be recognized that the hardware security module can be a separate module that is external to the sever or computer system and connects with the computer system or server through a standard interface port such as USB.

At least one cryptographic chip 120 disposed on the card 110 (illustrated as chips 120-1, 120-2, 120-3, 120-4, 120-N, collectively “120”). The cryptographic chip 120 is configured to perform cryptographic operations such as encrypting and decrypting digital signatures or performing secure authentication. As the chip is secure and the processing that it performs is highly sensitive, the chip needs to be protected from tampering with or being identified. In some embodiments the chip is configured with “self destruct” capabilities. These capabilities can be initiated by the chip in response to various types of detected intrusions. These intrusions can include Xray analysis of the chip, signals received from the security cover 130, temperature changes, etc. In response to the intrusion the chip, or the associated circuitry on the card 110 can cause the card 110 to protect itself. This can include deleting/destroying the security keys, destroying the circuitry on the chip (such as through the use of an acid or burning fuses), erasing an ASIC on board the card 110, etc. The end result of such response is that card 110 is “bricked” and unable to ever function again.

The hardware security module includes features that protect the underlying circuitry from being tampered with or otherwise altered. These protection features make tampering with the cryptographic components difficult and when tampering is detected can provide tamper evidence such as visible signs of tampering or logging and alerting. As discussed above, in some embodiments, the hardware security module can render itself inoperable in response to the detection of tampering. This can be on top of the evidence of tampering. To provide additional protection of the underlying cryptographic chips and circuitry, the hardware security module includes a security cover 130.

The security cover 130 is placed over at least the portion of the card 110 that is to be protected from tampering or other analysis. The security cover 130 covers both the front of the card 110 as well as the back of the card 110. In some embodiments the security cover 130 is comprised of two halves that are connected to the card 110 in a way that prevents examination of the covered contents. One side of cover may be larger than the other side to allow for the heights associated with the chips and other circuitry on the card 110. For example the half of the security cover 130 (illustrated as 131) that covers the top of the cryptographic chip 120 can have walls or sides that extend from the top portion of the security cover 130 down to card 110, thus creating a box like cover. The other half of the security cover 130 (illustrated as 132) that covers the other side of the card 110 may not have these walls or sides and can simply be attached to the card 110 over top of the associated circuitry. The security cover 130 can be made from a variety of materials that are capable of being cast into a mold. For example the security cover 130 can be made from aluminum or it can be made from a zinc, aluminum, magnesium, and copper alloy having various ratios of each of the metals. For example, the percentage of zinc can range between 90% and 97%, the percentage of aluminum can range between 3.4% and 4.3%, the percentage of magnesium can range between 0.01% and 0.6%, and the percentage of copper can range between 0.03% and 3.5%. In some embodiments, the security cover 130 can have objects attached to the outside of the cover, such as heat sink 150 illustrated in FIG. 1.

The flex cable 140 is part of the hardware security module that is used to detect various attempts to tamper with or inspect the hardware security module or the secure components on it. In order to make it difficult for a person to avoid the flex cable 140, the flex cable 140 is disposed within the material that forms the security cover 130. This is in contrast to current practice which places flex cable 140 on the inside surface of the security cover 130 using an adhesive to hold the cable onto the security cover 130. By knowing where the flex cable 140 is in the security cover 130 a person can strategically avoid the cable during an intrusion into the hardware security module. However, as the flex cable 140 is placed within the security cover 130, the exact location of the flex cable 140 can not be determined at all making it much more difficult to avoid detection. The flex cable 140 also includes circuitry and/or sensors that are designed to detect an intrusion of the security cover 130. This circuitry can be responsive to contact, such as from a drill or other probe, can be responsive to radiation, such as X-ray, and/or can be responsive to temperature changes. However, the circuitry in the flex cable 140 can be can configured to respond to any anticipated form of intrusion or tampering. In order to survive the casting process, the flex cable 140 is made from a material that is resistant to the heat required for casting the secure cover. For example, the flex cable 140 can be made using a bonding film such as DuPont Pyralux® HT (registered trademark of DuPont Electronics Inc of Wilmington, Del.) to cover the underlying electronics and circuitry in the flex cable 140.

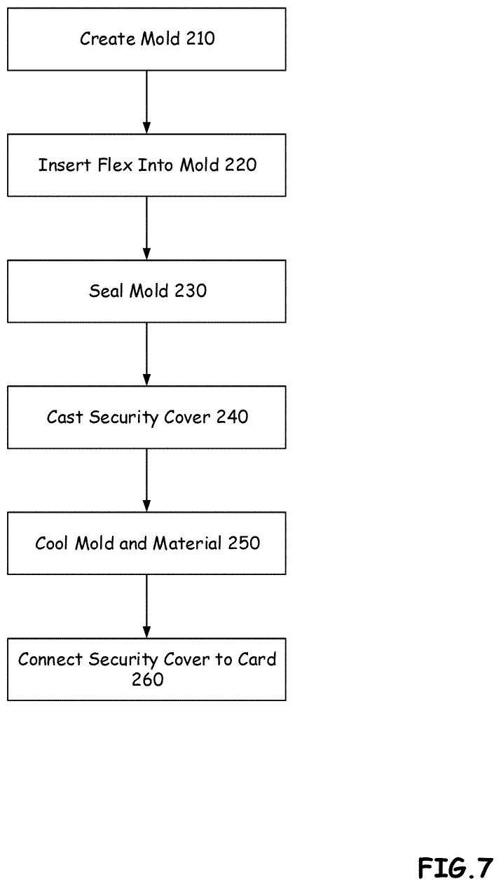

FIG. 7 is a flow diagram illustrating a process for making the security cover 130 for the hardware security module. The process begins by creating a mold for the security cover 130. This is illustrated at step 210. To create the mold a design and shape for the security cover 130 is determined. This shape can include dividing the security cover 130 into two separate halves. In this instance a mold is created for a bottom half of the security cover 130 and a separate mold is created for the top half of the security cover 130. The top half of the security cover 130 may be larger than the bottom half. The top half can have walls or other side panels which extend from the top surface of the towards a location where the top half will contact the card 110. The walls or side panels extend to such a distance as to allow the top half of the security cover 130 to provide enough clearance from the surface of the card 110 over the covered circuitry. The mold will have gaps in it such that a desired thickness of the security cover 130 can be achieved when casting the security cover 130. In some embodiments the mold will result in a single piece casting of the security cover 130.

Once the mold for the security cover 130 has been made, the security flex cable 140 is placed inside the mold. This is illustrated at step 220. The flex cable 140 is placed in the mold at a predetermined depth within the mold. In some embodiments, the predetermined depth is a constant depth. That is the flex cable 140 is at a constant distance from the outer surfaces of the security cover 130. In some embodiments, the predetermined depth is a variable depth. That is the flex cable 140 has a different distance from the outer surfaces of the security cover 130 at different locations within the mold. In some embodiments, the flex cable 140 is placed at a random depth within the mold that can vary between different castings of the security cover 130.

In some embodiments, to control the depth of the flex cable 140 in the mold and to ensure that the flex cable 140 stays in the desired location during casting, a material that disintegrates and or vaporizes at the casting temperature can be placed in the mold at the desired depth of the flex cable 140. The flex cable 140 is then placed on top of this material. The material can include for example, paper, cardboard, wax, or foam. While this process may leave residue inside the security cover 130, this residue does not adversely affect the performance of the security cover 130 or the flex cable 140. In some embodiments, the mold can include features that cause the flex cable 140 to position at a specific area within the mold. Features in the mold to place it.

In some embodiments, there are multiple flex cables placed within the mold. For example, additional flex cables can be placed in the walls or side panels of the security cover 130. In this way there are one or more flex cables in the top half 131 of the security cover 130.

Following the placement of the flex cable 140 into the mold, the mold is sealed such that casting of the security cover 130 can be performed. This is illustrated at step 230. The sealing of the mold can be done using any technique for covering the mold so as to allow for casting.

Next the casting of the security cover 130 is performed. This is illustrated at step 240. At this step a casting material in a liquid form is poured into the mold. For example, the casting material can be aluminum or it can be a zinc, aluminum, magnesium, and copper alloy having various ratios of each of the metals. For example, the percentage of zinc can range between 90% and 97%, the percentage of aluminum can range between 3.4% and 4.3%, the percentage of magnesium can range between 0.01% and 0.6%, and the percentage of copper can range between 0.03% and 3.5%. The molten liquid proceeds to fill in the space of the mold and forms around the inserted flex cable 140. This in essence allows the flex cable 140 to be incorporated within the security cover 130. If the material was used to place the cable at a specific depth, the heat from the casting material causes the material to vaporize while allowing the casting material to fill in the space vacated by the material. However, in other embodiments where the material is not present the depth of the flex cable 140 can be controlled during this casting process by controlling the flow rate of the casting material into the mold. A constant flow rate can be used to achieve a constant depth within the casting. Conversely to obtain an irregular or random depth, varying the flow rate of the casting material will cause the flex to settle at different depths within the mold.

Following casting, the material is allowed to cool. This is illustrated at step 250. Once the material has cooled the mold can be removed to reveal the cast security cover 130 with the flex cable 140 embedded in the security cover 130 without the use of any adhesives. This is illustrated at step 260. The security cover 130 can then be connected to the card 110 to cover the cryptographic portion of the hardware security module. The connection to the hardware security module can be any connection type used to connect the flex cable 140 to the card 110 and obfuscate the secure portion of the card 110.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A hardware security module comprising;
a card configured to be plugged into a computer system;
at least one cryptographic chip disposed on the card;
a security cover, the security cover having a first half and a second half, the first half of the security cover disposed on a first side of the card, and the second half of the security cover disposed on a second side of the card, wherein the security cover encloses the at least one cryptographic chip; and
a flex cable including at least one sensor configured to detect tampering with the hardware security module, the flex cable disposed within the security cover.

2. The hardware security module of claim 1 wherein the flex cable is disposed at a fixed depth within the security cover.

3. The hardware security module of claim 1 wherein the flex cable is disposed at a variable depth within the security cover.

4. The hardware security module of claim 1 wherein the flex cable further comprises:
a first flex cable disposed within the first half of the security cover; and
a second flex cable disposed within the second half of the security cover.

5. The hardware security module of claim 4 wherein the first flex cable is connected to the first side of the card, and the second flex cable is connected to the second side of the card.

6. The hardware security module of claim 4 further comprises:
a third flex cable disposed within the first half of the security cover, the third flex cable aligned perpendicular to the first flex cable and surrounding a perimeter of the first half of the security cover.

7. The hardware security module of claim 1 wherein the flex cable comprises a material having a heat resistance property greater than a casting temperature of a material used for forming the security cover.

8. A method of forming a security cover, comprising:
creating a mold for the security cover;
placing a security flex cable inside the mold;
sealing the mold;
casting the security cover by applying a liquified material into the mold; and
cooling the liquified material such that the flex cable is embedded within the security cover.

9. The method of claim 8 further comprising:
regulating a flow of the liquified material to place the flex cable at a predetermined depth within the security cover.

10. The method of claim 9 wherein regulating the flow of the liquified material varies the rate of the flow to place the flex cable at variable depths within the security cover.

11. The method of claim 8 wherein placing the flex cable inside the mold, places multiple flex cables inside the mold.

12. The method of claim 8 further comprising:
attaching the security cover to a card to form a hardware security module.

13. The method of claim 8 further comprising:
placing a material that is configured to disappear at a casting temperature inside the mold to hold the flex cable at a predetermined depth within the security cover.

14. A casted security cover comprising:
a flex cable including at least one sensor configured to detect tampering disposed within at least one portion of the security cover.

15. The security cover of claim 14 wherein the flex cable is disposed at a fixed depth within the at least one portion of the security cover.

16. The security cover of claim 14 wherein the flex cable is disposed at a variable depth within the at least one portion of the security cover.

17. The security cover of claim 14 further comprising:
a first flex cable disposed within a first portion of the security cover; and
a second flex cable disposed within a second portion of the security cover.

18. The security cover of claim 17 further comprising:
a third flex cable disposed within the first portion of the security cover, the third flex cable aligned perpendicular to the first flex cable and surrounding a perimeter of the first portion of the security cover.

19. The security cover of claim 14 wherein the flex cable comprises a material having a heat resistance property greater than a casting temperature of a material used for forming the security cover.
